(19) United States
(12) Patent Application Publication
(10) Pub. No.: US 2006/0169710 A1
(43) Pub. Date: Aug. 3, 2006

(54) Dispenser for use with hand-held objects

(76) Inventor: Diego Caracciolo Carbonell, Weston, FL (US)

Correspondence Address: DIEGO C. CARBONELL, 1325 SEAGRAPE CIRCLE, WESTON, FL, 33326, US

(21) Appl. No.: 11/047,085

(22) Filed: Jan. 31, 2005

(51) Int. Cl. B65H 1/00; F42B 39/02; B65G 59/00

(52) U.S. Cl. 221/45; 221/63; 221/185; 221/282

(57) ABSTRACT

A dispenser for portable consumables reduced in size from similar dispensers and having a refillable dock (22) with a layer of double-sided adhesive tape (38) on its undersurface to secure the dock to hand-held objects, and into which a dispensing receptacle (60) is removably inserted. In addition, the dispensing receptacle (60) is made of a material having flexible properties so that a lid (46) can be repeatedly opened and closed without fracturing along a hinge (50), the resulting dispenser having a smooth outer surface and a rounded contour to avoid snagging, and a size and profile consistent with the portability and streamlined profile of the hand-held object to which the dispenser is attached. The dispensing receptacle (60) can be adapted to be secured directly to a hand-held object without the need for the dock (22), and the lid can be adapted to slide along the body of the receptacle.

### CROSS-REFERENCE TO RELATED APPLICATIONS

None

### FEDERALLY SPONSORED RESEARCH

Not applicable

### REFERENCE TO A MICROFICHE APPENDIX

None

### SEQUENCE LISTING OR PROGRAM

None

### BACKGROUND OF THE INVENTION—FIELD OF THE INVENTION

This invention relates to dispensers for portable consumables, specifically to dispensers for such portable compact breath fresheners known as intense breath fresheners or breath strips.

### BACKGROUND OF THE INVENTION—INTRODUCTION

People are very serious about having good breath and a fresh mouth feeling at all times. Breath-freshening confections such as mints and gum have been around for a long time to help consumers refresh their breath when teeth-brushing or other oral hygiene practices are not an option. In this sense, it is important that breath-fresheners be portable and retrievable for use anytime, and anywhere.

Typically, consumers store breath fresheners in a pocket or purse. Breath fresheners can come in very small, low profile dispensers, and when they are that inconspicuous, they can be very easily misplaced or lost, also hard to find and handle. This can make it difficult for a user to remember to consume the product. Breath freshener efficacy is largely a matter of regular and timely consumption—that is, providing the user with breath fresheners in a dispenser that can be easily located, accessed, retrieved, handled, operated and saved from oblivion despite its unobtrusive size, shape and volume.

### BACKGROUND OF THE INVENTION—RECENT DEVELOPMENTS

Recently, a new confection known as breath strips came to the market to compete in the oral care field. These breath strips are marketed under consumer brands such as Pfizer's Listerine POCKETPAKS®, Callard & Bowser Suchard's ALTOIDS® Strips, and Wm. Wrigley Jr. Company's ECLIPSE FLASH® Strips, among others. The unusually compact breath-freshening confection consists of flat, very thin translucent rectangular sheets measuring about 3.2 cm by 2.2 cm (1¼″ by ⅞″) and which instantly dissolve on the tongue releasing an intense minty flavor designed to freshen breath.

Another similar confection consisting of translucent, colored mini-spheres having a diameter of about 4 mm ( 3/16″) and which dissolve instantly on the tongue to release an intense breath-freshening liquid have also populated store shelves and displays under consumer brands such as Hershey Foods Corporation's ICE BREAKERS®, Wild-X's BREATHFUSION®, and Yosha Enterprises' MOMINTS®.

These new compact but intense confections are marketed as “pocket-sized,” “discreet,” “fit-anywhere,” “take-anywhere,” and “convenient-sized” breath-fresheners, with the key selling point being that the product packaging fits conveniently in a pocket or purse. Thus, the concentrated nature of the mints allows for the offering of an unusually compact confection in a consequently small dispenser while providing a freshening effect at least as intense and effective as that of other more voluminous, bulkier breath fresheners.

The strips and spheres usually come stored in very small and flat plastic or metal disposable dispensers usually measuring about 4.5 cm by 3 cm by 0.75 cm thick (1¾″ by 1⅛″ by ¼″ thick). The spheres are also available in cylinders measuring about 1 cm by 5 cm long ( 5/16″ wide by 2″ long) to accommodate the round confections one of top of another.

The breath strips and spheres (collectively referred to as “intense breath-fresheners” from this point forward) and the unusually small dispensers that house them, were introduced in the U.S., Puerto Rico, and West Indies in October 2001, after selling in Canada since mid 2000. Before that point, there were very few instances of truly portable dispensers. For the purposes of this disclosure, truly portable dispensers are those intended for carrying everywhere and at all times, and which have unusually small dimensions (no larger than 4.5 cm by 3 cm by 0.75 cm thick −1¾″ by 1⅛″ by ¼″ thick-). In this sense, the very nature of dispensers for this compact and relatively new product presents a number of new problems not encountered before, and for which limited prior art exists that applies directly to this type of portable dispensers and confections.

For instance, the unusually small size of the dispenser makes it difficult to find, retrieve, handle, and operate; it also makes it easy to drop and misplace. Its low profile tends to keep it out of sight/out of mind when stored, reducing the usage frequency of the product to less than desirable levels.

In addition, the instant-dissolving feature of the confections makes them particularly sensitive to humidity and temperature, to the point that the labeling on the packaging and dispenser urges users to store the dispensers in dry places and at relatively cool temperature ranges (around 55° to 77° F.), and to avoid heat and humidity.

Thus, when the dispenser is stored in warm and humid places such as a pocket that rests against the skin, the confections tend to stick to one another, further complicating the dispensing of the confection. Another problem of these dispensers is that their small size may pose a choking hazard, as stated by the warnings on the packaging and dispenser labeling.

Moreover, further reducing the size of the confections and consequently the dispenser could enhance portability given that the concentrated intensity of the confection allows for the offering of a more compact breath freshener in an unusually small dispenser without sacrificing the power of the freshening effect.

For example, the size of the breath strips could be reduced in half from their standard size of about 3.2 cm by 2.2 cm (1¼″ by ⅞″) to about 1.6 cm by 2.2 cm (⅝″ by ⅞″) and their hairline thickness doubled, thereby retaining their freshening capacity. However, the degree of miniaturization of the dispenser is limited by its functionality, i.e., the resulting smaller size of the dispenser would accentuate many of the problems described above (even harder to find, retrieve, handle and operate; even more likely to be dropped and its contents spilled, even more of a choking hazard posed, etc).

### BACKGROUND OF THE INVENTION—PRIOR ART

Dispensers for intense breath fresheners are known. U.S. Pat. No. 6,726,054 issued on April 2004 to Fagen et al (PRIOR ART, FIG. 16A), U.S. Pat. No. 6,669,020 issued on December 2003 to Mamiiye (PRIOR ART, FIG. 16B), and No. D423,302 issued on April 2000 to Haner et al (PRIOR ART, FIGS. 17A and 17B), show such dispensers.

Fagen's disposable dispenser provides a blister portion with a backing construction and an adhesive surface to allow one to open and reseal the blister portion of the dispenser against the backing construction. Mamiye's re-sealable blister breath strip case has a rear flap for accomplishing a somewhat similar objective to Fagen's dispenser, and Haner's patent provides an ornamental design for a disposable breath strip dispenser.

However, these dispensers are difficult to detect and retrieve when stored, complicated to handle; easy to misplace and drop; and tend to stay out of sight/out of mind reducing the usage frequency of the product to less than desirable levels.

In addition, as truly portable dispensers, they are intended for storage in a pocket or similar compartment. Thus, when the dispenser is stored in a pocket that rests against the skin, the heat and humidity may cause the confections to stick to one another. A similar situation happens when one leaves the dispenser exposed to direct sunlight, such as in a car or by a window. In addition, the small size of these dispensers may pose a choking hazard.

Also known are accessories to enable dispensers for intense breath fresheners to be latched onto predetermined places. Pfizer Consumer Healthcare markets a refillable rubber case for inserting a dispenser of its Listerine POCKETPAKS® branded oral care strips therein and having a 2-piece pressure-action hook-type plastic clasp attached to the rubber case using a connecting metal ring (PRIOR ART, FIG. 17C).

However, the clasp can only be secured to limited locations having a loop or similar structure such as a pant belt loop, and needs to be unlatched from one location and latched onto another on a regular basis, thereby increasing the chances that the dispenser will be forgotten or left behind. Moreover, the clasp, case, and ring assembly represents additional bulky, obtrusive, and expensive hardware that further complicates handling and operation of the unit, makes the dispenser highly prone to snags, and contributes to increasing the overall cost of the product.

The refillable rubber case for inserting a dispenser of intense breath fresheners and having a key chain ring shown in FIG. 17D of the PRIOR ART (available at retailers nationwide) suffers from similar problems as the device shown in FIG. 17C of the PRIOR ART.

### BACKGROUND OF THE INVENTION—PRIOR ART FROM DIFFERENT FIELDS

Even though from different fields and having different uses, U.S. Pat. No. 5,358,141 issued on October 1994 to Carlson et al (PRIOR ART, FIG. 18) and U.S. Pat. No. 5,086,946 issued on February 1992 to Blackwell et al (PRIOR ART, FIG. 19), both show reusable dispensers for pressure sensitive adhesive coated sheets as well as a support or attachment mechanism to which such dispensers can be attached.

U.S. Pat. No. 5,222,643 issued to Platt on June 1993 shows a hair treatment servicing container having a band to secure the dispenser to the back of the hand (PRIOR ART, FIG. 20).

Platt's, Carlson's and Blackwell's dispensers provide attachment mechanisms to facilitate the handling and dispensing of a product for tasks which generally require the use of both hands for operating other than the dispensing of the product and while working at a predetermined time and location. However, these dispensers do not address nor solve the problems posed by significantly smaller portable dispensers such as those for intense breath fresheners (namely, hard to find, retrieve, handle and operate; likely to be dropped and its contents spilled, sensitivity to humidity/ temperature, choking hazard, etc).

Therefore, they should not be considered to be in the same technical field as portable disposable dispensers for intense breath fresheners, but what they clearly are—larger reusable dispensers for pressure sensitive adhesive coated flexible sheets for use at a predetermined time and location. This eliminates the need to carry the dispenser around everywhere and at all times, as is the case with dispensers for intense breath-fresheners.

In this sense, Carlson states “a dispenser for pressure sensitive adhesive coated flexible sheets from a stack of such sheets adhered one of top of another, which sheets may, for example be used for securing gift wrapping paper, marking electrical wire, or highlighting potions of a document”.

Blackwell writes, “The pre-cut sheets of the present invention are particularly useful for tasks which generally require the use of both hands for operating other than the dispensing of the tape, such as for example, gift wrapping, wire marking and highlighting.”

Platt's patent reads: “It is an object of this invention to provide a container to hold the hair treating material close to the customer's head for easy application to the hair while leaving both of the stylist's hands free to apply the material to the hair.”

Clearly, the attachment mechanisms of Platt's, Carlson's, and Blackwell's dispensers do not address nor solve the problems posed by significantly smaller portable dispensers such as those for intense breath fresheners (namely, portability, hard to find, retrieve, handle and operate; likely to be dropped and its contents spilled, sensitivity to heat/humidity, choking hazard, etc).

Another U.S. patent from a different technical field, U.S. Pat. No. 5,127,545 issued to French on July 1992, describes a pouch for holding and dispensing facial tissues (PRIOR ART, FIG. 21). French describes the invention as “designed to be attached to the forearm of the user even over outer garments which are typically worn during such activities as skiing, (. . . ) hunting and almost any activity which may make it normally inconvenient, while engaged in the activity, to get a facial tissue and properly store it after use for later and proper disposal.” This patent does not address nor solve the problems posed by significantly smaller portable dispensers such as those for intense breath fresheners (namely, hard to find, retrieve, handle and operate; likely to be dropped and its contents spilled, sensitivity to heat/humidity, choking hazard, etc).

### BACKGROUND OF THE INVENTION—PROBLEMS AND DISADVANTAGES OF PRIOR ART

As can be seen, several types of portable dispensers exist for intense breath fresheners that do in fact fit almost anywhere, can be taken anywhere, and are virtually unnoticeable and unobtrusive when carried in a pocket or similar compartment. Nevertheless, all of the dispensers for intense breath-fresheners heretofore known suffer from a number of problems and disadvantages:
(a) They are easily misplaced as a result of their small size,
(b) When stored, they are hard to detect, whether visually or using the sense of touch (pat down) due to their small size and low profile,
(c) They are hard to find when stored in a compartment containing other objects, as a result of their small size,
(d) When stored in a deep pocket or other hard-to-access compartment, they are difficult to fetch and retrieve as a result of their small size,
(e) They are complicated to handle and awkward to operate, i.e., opening the lid, holding the dispenser while removing the confection, and closing the lid when done, as a result of the small dimensions of their parts,
(f) They are unstable and insecure when being handled as a result of their small size,
(g) They are easy to drop as a result of their handling instability,
(h) They increase the chances of spilling the product as a result of handling instability,
(i) When stored in a warm and or humid compartment such as a pocket that rests against the skin, the confections tend to stick to one another, given the instant-dissolving feature of the confections,
(j) When left exposed to sunlight, the dispenser heats up and builds humidity, thereby causing the confections to stick to one another, given the instant-dissolving feature of the confections,
(k) They tend to stay out of sight, and therefore “out of mind”, increasing the likelihood that the user will forget to use the product regularly, thereby reducing the usage frequency of the product to less than desirable levels,
(l) They may pose a choking hazard as a result of their small size,
(m) Further reducing the size of the dispenser would accentuate many of the problems described above and,
(n) Once empty, the entire dispenser must be discarded.

### BACKGROUND OF INVENTION—OBJECTS AND ADVANTAGES

Accordingly, several objects of the present invention are:
(a) To provide a dispenser for confections that is difficult to misplace in spite of its reduced size, and while keeping consistency with portability
(b) To provide a dispenser for confections that can be easily detected when stored, whether visually or using the sense of touch (patted down), in spite of its low profile,
(c) To provide a dispenser for confections that can be easily found when stored in a compartment containing other objects, in spite of its reduced size,
(d) To provide a dispenser for confections that can be easily fetched and retrieved when stored in deep pockets and other hard-to-access compartments, in spite of its reduced size,
(e) To provide a dispenser for confections that is easy and convenient to handle and operate, that is, one that is easy to hold, that allows easy opening of the lid, easy removal of contents, and easy closing of the lid when done,
(f) To provide a dispenser for confections that remains stable and secure while being handled, that is, while being held, while the lid is opened, the contents removed, and the lid is re-closed, in spite of the small dimensions of the unit and its parts,
(g) To provide a dispenser for confections that is difficult to drop as a result of its handling stability,
(h) To provide a dispenser for confections that can help prevent spilling its contents,
(i) To provide a dispenser which can be stored in most types of compartments, including those that may be warm and/or humid such as a pocket that rests against the skin; without causing the confections to stick to one another in spite of the instant-dissolving feature of the confections,
(j) To provide a dispenser that can help prevent exposure to direct sunlight, heat and humidity buildup, thereby reducing the tendency of the confections to stick to one another in spite of the instant-dissolving feature of the confections,
(k) To provide a dispenser for confections that can increase the likelihood that a user will remember to use the product, thereby regulating the usage frequency of the product to desirable levels,
(l) To provide a dispenser that minimizes or eliminates the choking hazard risk despite its small size,
(m) To provide a dispenser for breath fresheners still further reduced in size from that of existing dispensers for breath fresheners while reducing or eliminating the problems presented by current dispensers for breath fresheners as described under BACKGROUND OF THE INVENTION—PROBLEMS AND DISADVANTAGES OF PRIOR ART on pages 10 and 11; points (a) to (m), and
(n) To provide a dispenser for confections that can be refilled or re-used at least in part to lower costs.

Further objects and advantages are to provide a dispenser that is simple to use and inexpensive to manufacture, that encourages users to consume the product frequently, and that promotes brand loyalty and repeat purchase among consumers. Still further objects and advantages will become apparent from a consideration of the ensuing description and drawings.

### SUMMARY OF THE INVENTION

In accordance with the present invention a dispenser for portable consumables comprises a dock having an adhesive surface to secure the dock to a surface of a predetermined hand-held object, and into which a removable receptacle is secured, the resulting assembled unit having a smooth rounded outer surface consistent with the portability and streamlined profile of the hand-held object to which the dispenser is attached.

In the drawings, closely related figures have the same number but different alphabetic suffixes.

### DRAWINGS—FIGURES

FIG. 1 shows the dispenser in use.

FIGS. 2A and 2B show different perspectives of the dispenser.

FIGS. 2C and 2D show the dispenser with the lid open.

FIG. 3 shows an exploded view of the dispenser.

FIGS. 4A to 4E show different aspects of the dock.

FIGS. 5A to 5C show different aspects of the receptacle base.

FIG. 6A to 6C show different aspects of the lid.

FIG. 7A shows a general perspective of the receptacle cover.

FIGS. 7B and 7C show cross-sections of the receptacle cover.

FIGS. 8A to 8C show views of the assembled receptacle.

FIG. 8D shows a detail of the assembled receptacle.

FIG. 9 shows how the receptacle is inserted into the dock.

FIGS. 10A and 10B show cross-sections of the dispenser.

FIGS. 11A to 12C show additional embodiments of the dispenser.

FIGS. 13A to 14N show alternative embodiments of the dispenser.

FIGS. 15A to 15F show the operation of the dispenser.

FIGS. 16A to 21 show the prior art.

### DRAWINGS—REFERENCE NUMERALS

| | |
|---|---|
| 22. | Dock |
| 24. | Receptacle base |
| 26. | Receptacle cover |
| 28. | Domical protuberance |
| 30. | Dock corner |
| 32. | Slanted dock walls |
| 34. | Rounded outer surface |
| 36. | Paper liner |
| 36. | Corner of paper liner |
| 38. | Double-sided adhesive tape |
| 40. | Dock floor |
| 41. | Receptacle base edge |
| 42. | Dimple |
| 43. | Receptacle base floor |
| 44. | Ribs |
| 46. | Lid |
| 48. | Lid fin |
| 49. | Lid rib |
| 50. | Living hinge |
| 51. | Ridges |
| 52. | Receptacle base walls |
| 54. | Groove |
| 55. | Rounded cover ceiling |
| 56. | Recess |
| 56′. | Recess edge |
| 57. | Boundaries of aperture |
| 58. | Receptacle cover walls |
| 59. | Cover edge |
| 60. | Assembled receptacle |
| 62. | Alternate cover |

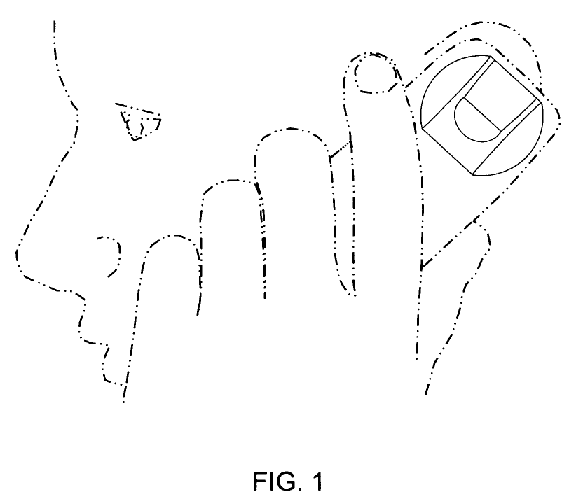

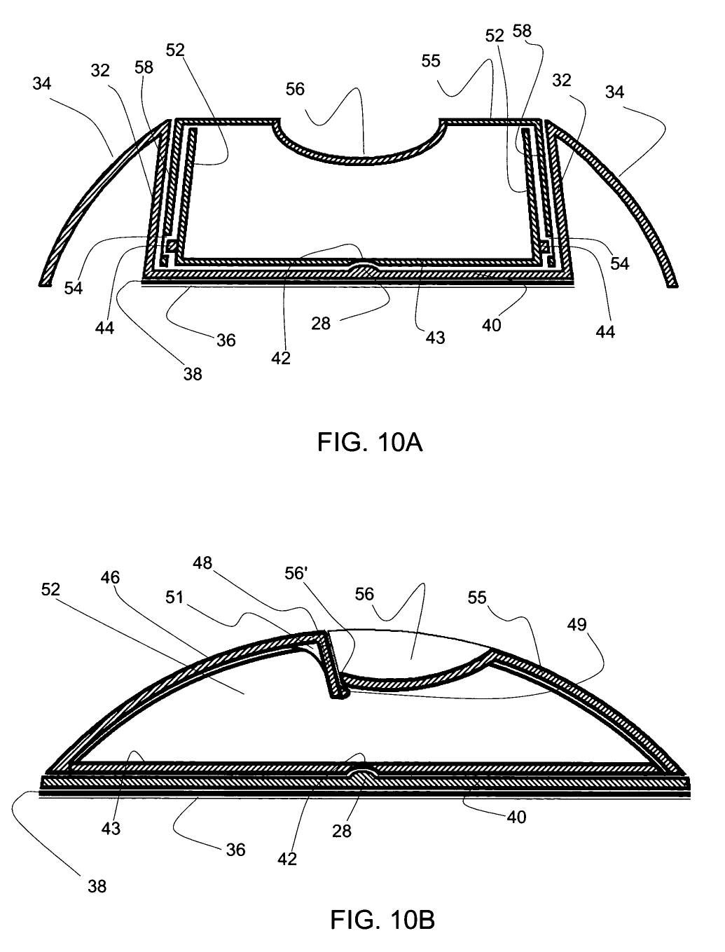

### DETAILED DESCRIPTION—FIGS. 1 TO 10B—PREFERRED EMBODIMENT

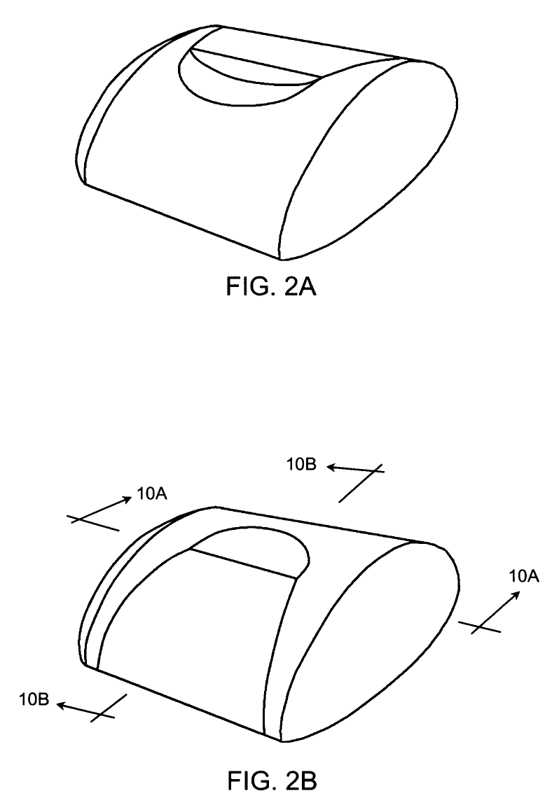

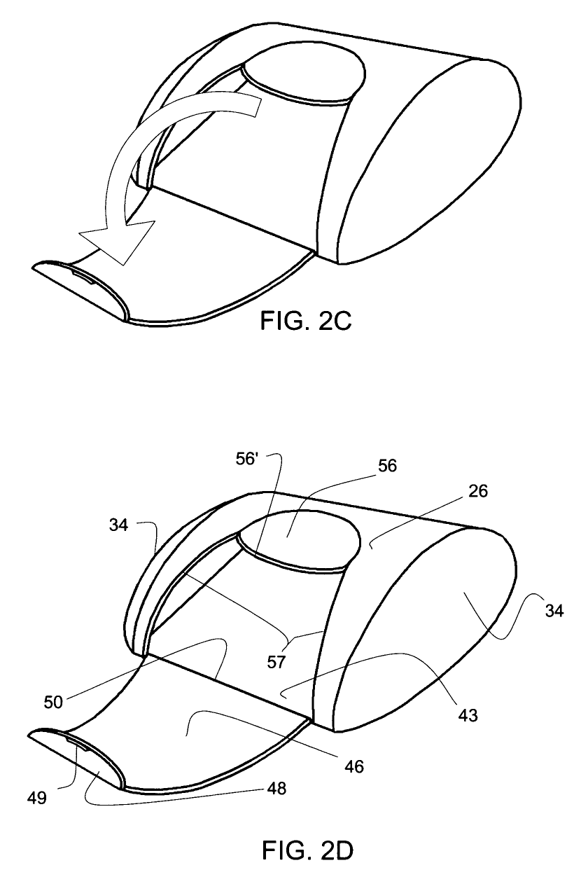

A preferred embodiment of the dispenser of the present invention is shown in use in FIG. 1 attached to a hand-held object, in this case to the back of a cell phone. The preferred embodiment of my dispenser is illustrated in FIGS. 2A (back perspective with closed lid), 2B (front perspective with closed lid), 2C and 2D (front perspectives with open lid), and FIG. 3 (exploded view) which shows the three main components of the preferred embodiment of my dispenser: A dock 22, a receptacle base 24, and a receptacle cover 26. A double-sided adhesive tape 38 and a removable paper liner 36 are part of dock 22 and are shown in exploded view in FIG. 3.

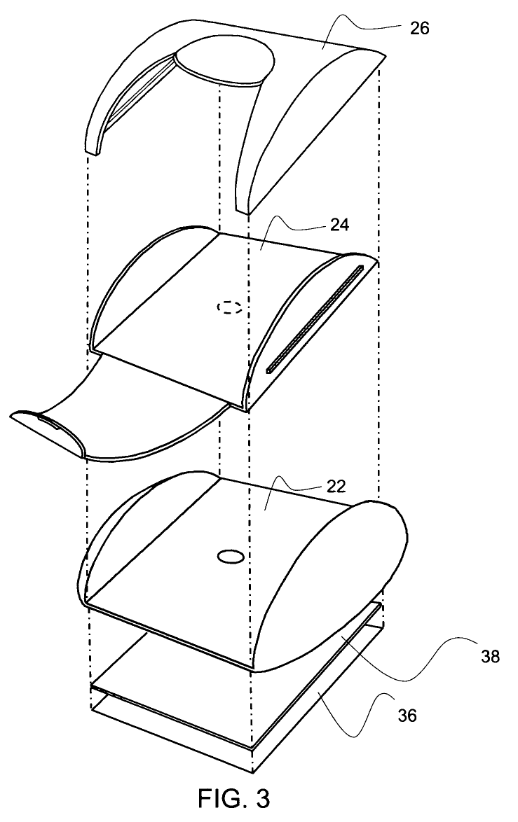

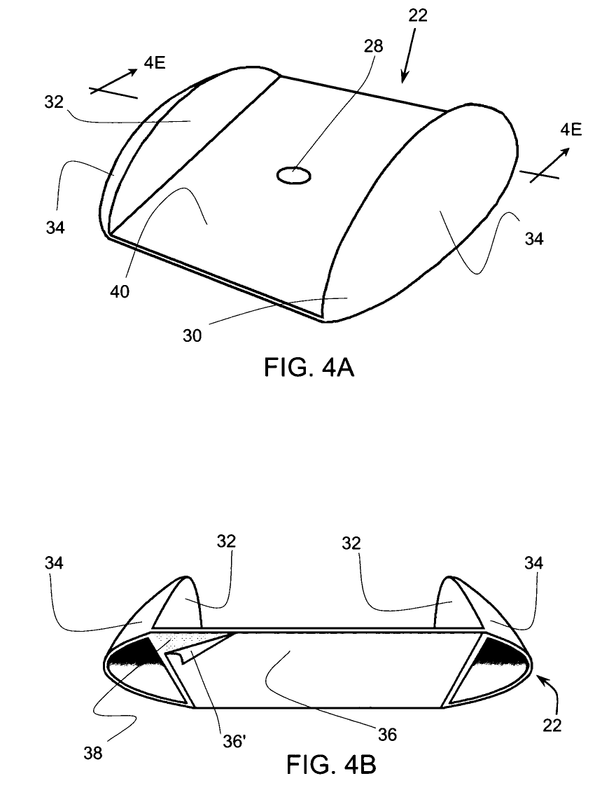

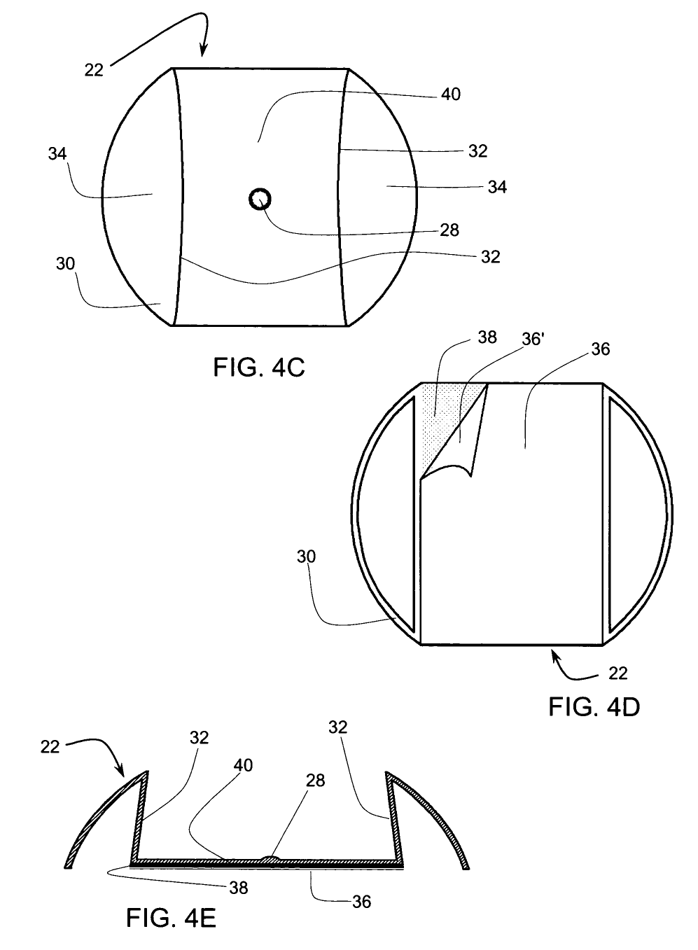

The component closest to the bottom, dock 22, seen in FIGS. 4A, 4B, 4C, 4D, and 4E; has a generally rounded shape (clearly seen in FIGS. 4C—top view; and 4D—bottom view), with two inward slanted inner dock walls 32 facing each other and having rounded outer surfaces 34 (FIGS. 4A, 4B, and 4E). Outer surfaces 34 and corners 30 of dock 22 are typically rounded to avoid snagging.

The undersurface of dock 22, seen in FIGS. 4B and 4D; is laminated with a layer of double-sided adhesive tape 38 (available from Shurtape Technologies, LLC; 1506 Highland Avenue NE, Hickory, N.C. 28601, U.S.A). The opposite side of tape 38 is protected with removable paper liner 36. For purposes of clarity, a corner 36′ of liner 36 is shown partially peeled back from tape 38 in FIGS. 4B and 4D.

A domical protuberance 28 is located at the center of the upper surface 40 of dock 22, equidistant from walls 32 as seen in FIGS. 4A, 4C, and 4E. In the preferred embodiment, dock 22 is made by injecting a resin such as polypropylene (available from Borealis Compounds LLC, of 176 Thomas Road, Port Murray, N.J. 07865, U.S.A.) into an injection mold to produce a piece of rigid plastic. However, the dock can be made employing any other suitable procedure and resin to produce any other rigid material that can hold its shape without breaking such as polyethylene, nylon, rubber, vinyl, various metals, etc.

Tape 38 is available in a roll with only one surface protected by a paper liner 36. Once dock 22 is produced and lined up on the production line, tape 38 is unrolled and the exposed adhesive surface is pressed against the undersurface of dock 22. The extra tape is then cut off and dock 22 is ready for packaging or to be assembled with the other components.

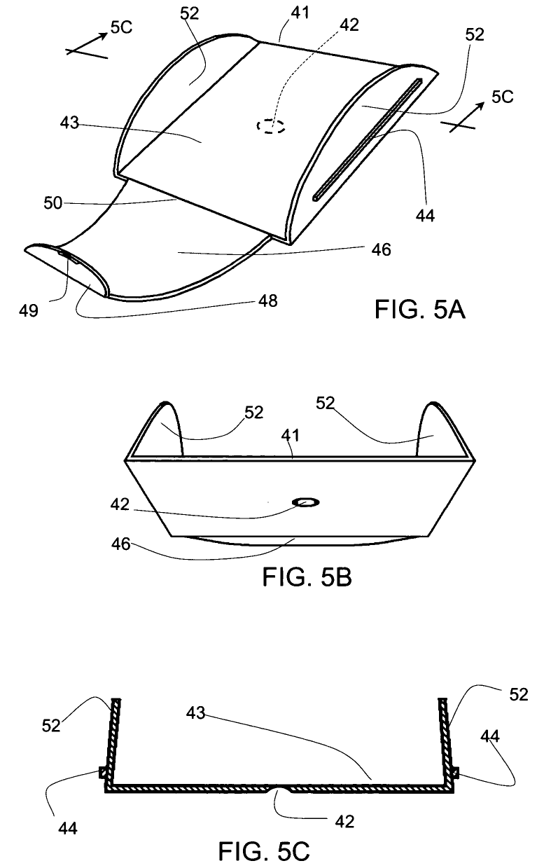

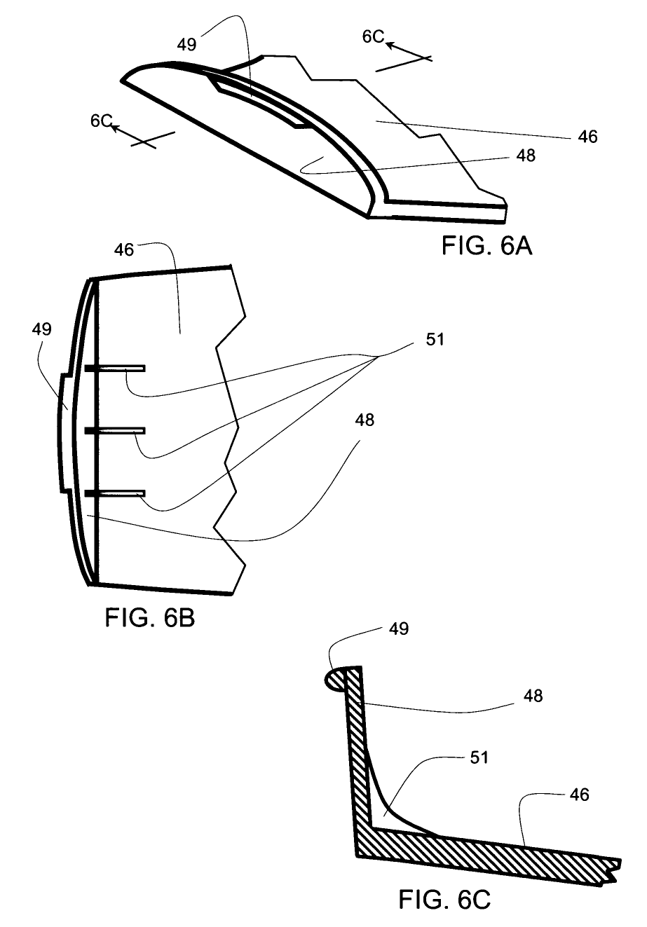

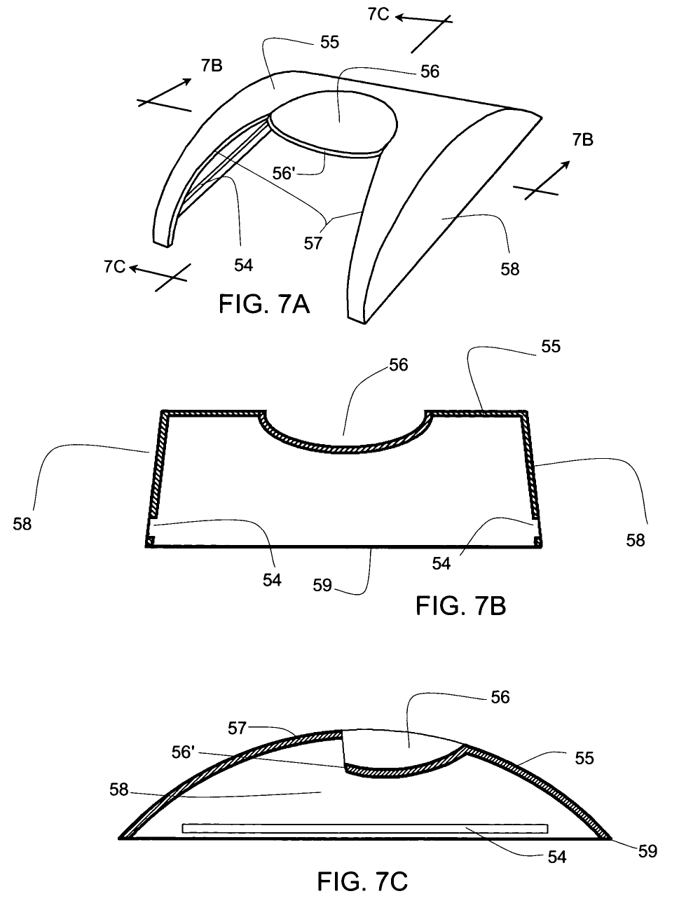

Another main component of the preferred embodiment of my dispenser, base 24 (shown exploded in FIG. 3, detailed in FIGS. 5A to 6C); is sandwiched between dock 22 and cover 26 (this latter part is shown in FIGS. 7A to 7C and will be described next). Base 24 consists of a generally square floor portion 43 having two inward slanting walls 52 of a rounded top perimeter and originating from opposite edges of floor 43.

A horizontal rib 44 shorter than the length of wall 52 is centrally disposed near the bottom of the outer surface of each of walls 52. A dimple 42 is disposed on the undersurface of floor 43 so it fits and snags over protuberance 28 of dock 22, and a curved lid 46 is joined to an edge of floor 43 by a living hinge 50. Lid 46 (seen in FIG. 5A and detailed in FIGS. 6A to 6C) ends in a fin 48 disposed perpendicularly to the outermost edge of lid 46 and having a rounded top perimeter and a rib 49 centrally disposed on the outer edge of fin 48. The inner surface of the angle formed by the joint of fin 48 and lid 46 has a number of sloping ridges 51, clearly seen in FIGS. 6B and 6C.

In the preferred embodiment, base 24 is made by injecting a resin having certain flexible properties such as polypropylene into an injection mold to produce a piece of plastic with a living hinge. However, base 24 can be made employing any other suitable procedure and resin to produce any other material that allows the living hinge to be flexed repeatedly without fracturing such as polyethylene, rubber, etc.

Finally, cover 26 (shown exploded in FIG. 3, detailed in FIGS. 7A to 7C) constitutes the uppermost component of the preferred embodiment of my dispenser. Cover 26 has a curved ceiling 55 with two inward slanted walls 58 adjacent to the perimeter of two opposite edges of ceiling 55.

A horizontal groove 54 shorter than the length of wall 58 is centrally disposed near the bottom of the inner surface of each wall 58. A round recess 56 wide enough to accommodate the width of an index finger is centrally formed at the top of ceiling 55. A v-shaped aperture delimited by boundaries of aperture 57, diameter 56′, and hinge 50 extends about half the length of ceiling 55 from the diameter of an edge 56′ of recess 56 to an edge of cover 26.

In the preferred embodiment, cover 26 is made by injecting a resin having translucent properties such as polypropylene into a mold to produce a see-through piece of plastic. However, cover 26 can be made employing any other suitable procedure and resin to produce any other suitable translucent or opaque material such as polyethylene, nylon, etc.

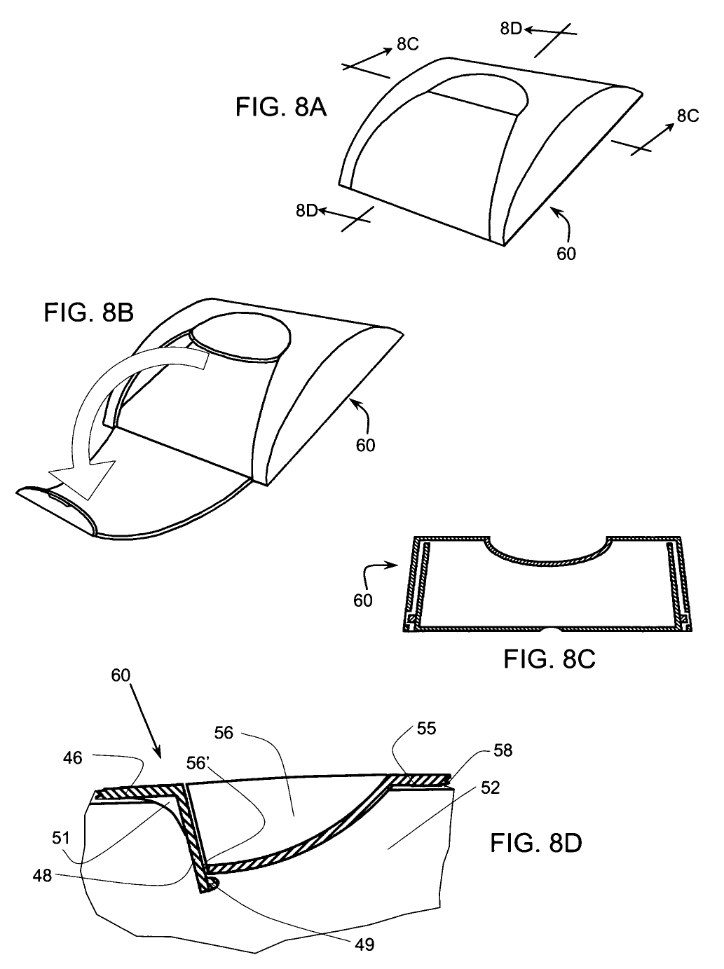

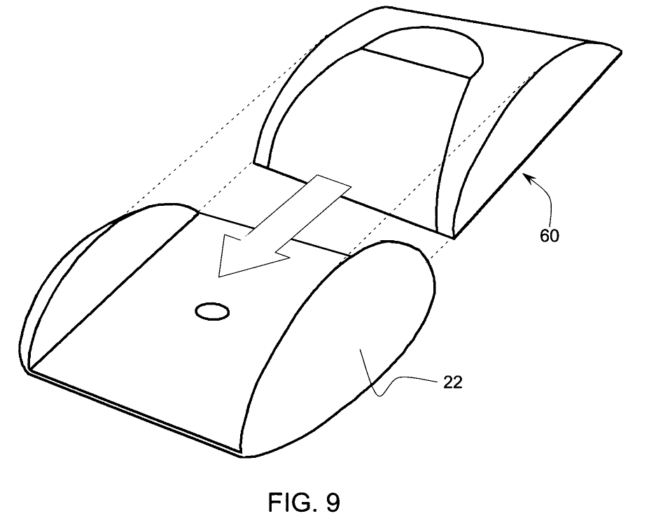

In the preferred embodiment of my dispenser, base 24 and cover 26 are individually injected as described above. To assemble the dispenser, base 24 is first filled with the confection on the production line and then cover 26 is snapped in place over base 24 (both shown in exploded view in FIG. 3) by urging ribs 44 of base 24 (FIGS. 5A and 5C) into grooves 54 of cover 26 (FIGS. 7A to 7C), thereby forming an assembled receptacle unit 60 shown in FIGS. 8A to 8D. Finally, unit 60 is inserted—and can be removed at a later time—into dock 22, (FIG. 9) from either open side so that the surfaces of inward slanting walls 32 of dock 22 clamp down on unit 60, and so that dimple 42 of base 24 snaps in place over protuberance 28 of dock 22.

Base 24 and cover 26 can also be made in one piece using the mold injection procedure, where base 24 and cover 26 would be joined by a hinge at an edge 41 of base 24 (FIGS. 5A and 5B) and an edge 59 of cover 26 (FIGS. 7B and 7C), so cover 26 folds over base 24 at the resulting hinge and snaps in place by urging ribs 44 of base 24 (FIGS. 5A and 5C) into grooves 54 of cover 26 (FIGS. 7A to 7B), to form assembled receptacle unit 60 shown in FIGS. 8A to 8D.

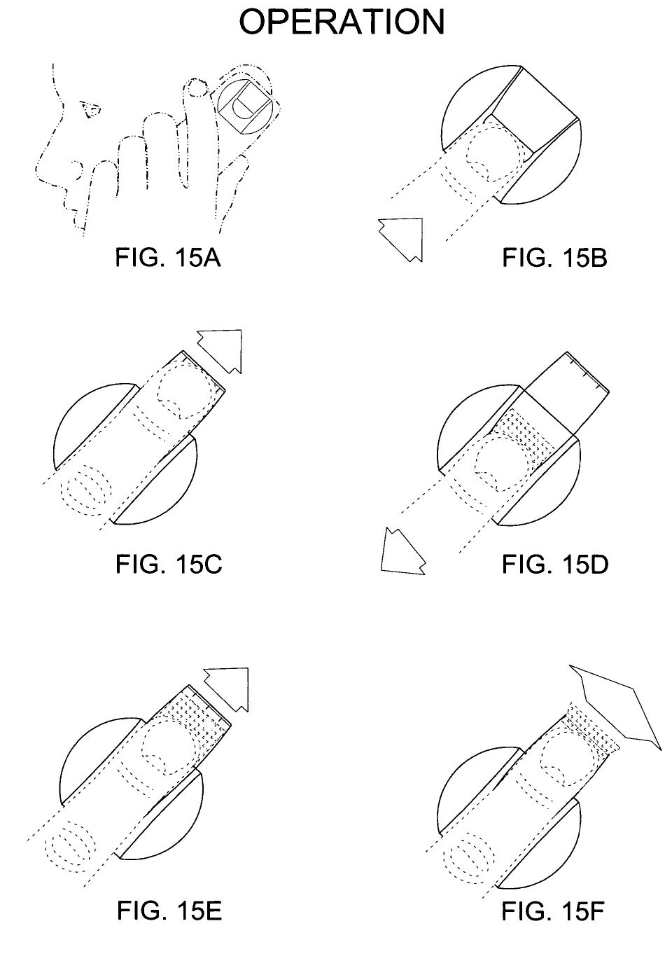

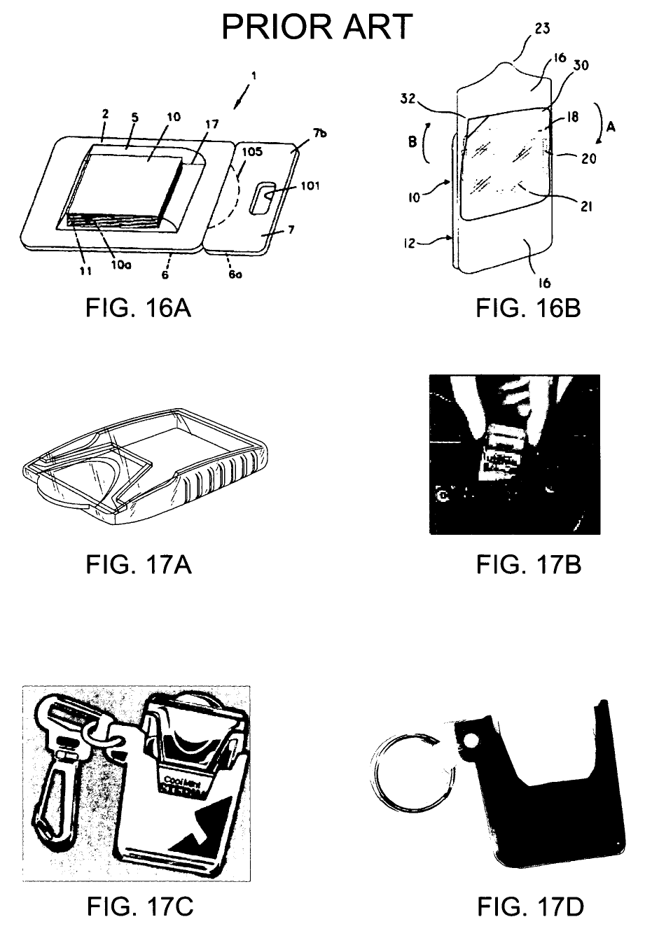

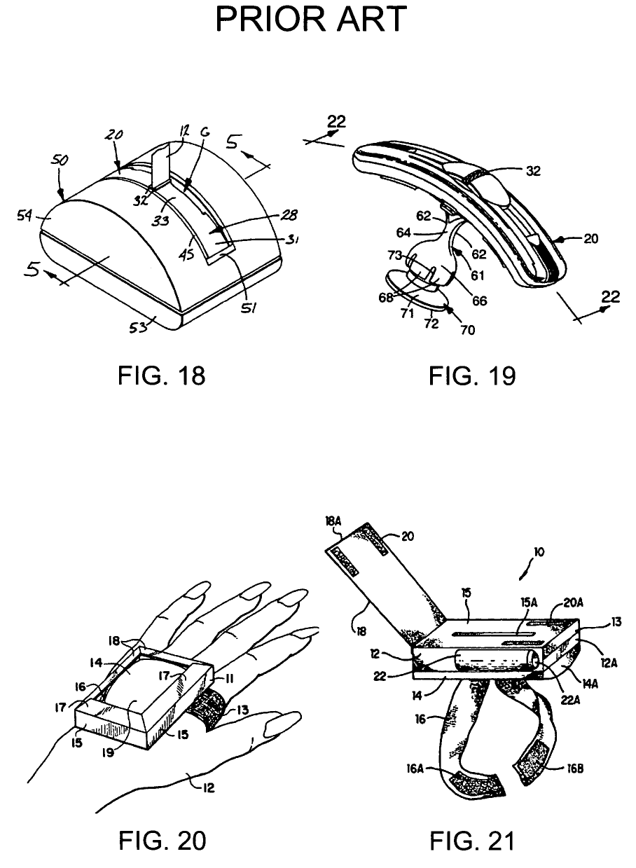

### OPERATION—FIGS. 15A TO 15F

After removing dock 22 and receptacle 60 from the package (or after removing the entire unit if the dispenser is already assembled), one first peels and removes paper liner 36 from tape 38 located on the undersurface of dock 22. One then positions dock 22 against a suitable surface of a conventional hand-held object such as the back of a cellular phone, an MP3 player, a personal digital assistant (PDA), a small book or agenda, or any other hand-held object that one can carry around at all times, and presses the exposed adhesive surface of tape 38 against the selected surface. One then inserts receptacle 60 (if not already inserted) into either end of dock 22 preferably with hinge 50 pointing towards the top when hand-held object is in regular use as shown in FIG. 15A so contents do not spill out when lid 46 is open.

To dispense the product once assembly of the dispenser is complete and dispenser is secured to hand-held object, one holds the hand-held object in one hand as one normally would as the example shows in FIG. 15A, with the dispenser attached. One then glides the tip of the index finger of the same hand into recess 56 of the dispenser as shown in FIG. 15B, and urges pressure against lid fin 48 so rib 49 disengages from recess edge 56′ as shown in FIG. 15C.

Then, one retracts the finger and inserts finger tip into the V-shaped opening of the dispenser as shown in FIG. 15D. One then slides out a sheet of the product as seen in FIG. 15E, all the way out so that the leading edge of the sheet presses against ridges 51 on fin 48 and folds upward as seen in FIG. 15F. Finally, one removes the sheet using the fingers of the other hand, the lips, etc, and then snap closes lid 46 with the same index finger.

Once empty, one urges the receptacle out of dock 22 and discards it, and inserts a new receptacle unit 60 into dock 22.

### OPERATION—ADVANTAGES

To quickly find the dispenser, one only needs to find the hand-held object to which it is secured. The chances of locating the dispenser quickly and easily are increased given that the hand-held object can be more easily detected whether visually or using the sense of touch (patted down) than the smaller dispenser on its own. Even when stored in a compartment with other objects, the larger hand-held object acts as a “bread crumb” allowing one to find the dispenser quicker and easier. When stored in a deep pocket or other hard-to-access compartment, the larger, bulkier hand-held object acts as an extension of the dispenser thereby allowing for easier fetching and retrieving of the unit than the dispenser would allow on its own.

In addition, by providing a larger holding body, the hand-held object makes handling and operating of the dispenser more convenient and easier by enhancing one's ability to open the lid, remove the contents, and re-close the lid with only one finger if so desired, while the rest of the hand conveniently holds the hand-held object as it normally would. Handling stability is also enhanced when operating the dispenser and while holding the hand-held object, thereby reducing the likelihood of dropping the dispenser, and/or spilling its contents.

To store the dispenser in a warm and/or humid compartment such as a pocket that rests against the skin, without causing the confections to stick to one another, one places the hand-held object into the compartment with the dispenser facing away from the source of warmth/humidity, whereby the hand-held object acts as a layer of insulation between the dispenser and the source of warmth/humidity.

Likewise, when the unit is left exposed to direct sunlight or other source of heat, the buildup of heat and humidity in the dispenser can be significantly reduced or avoided altogether by laying the unit down on a surface with the dispenser facing away from the source of light, so the hand-held object acts as a sunshade or sun block, casting a shadow over the dispenser to lower temperature and reduce the tendency of the confections to stick to one another.

The dispenser helps increase the likelihood that users will remember to use the product regularly by allowing users to attach the dispenser to a conspicuous area of the hand-held object as a way to provide a visual cue about the availability of the product each time the hand-held object is spotted, picked up or used.

The conspicuous area where the dispenser is secured may also be a location on the object which comes in contact with a user's sense of touch—such as an index finger—so as to provide an additional sensory cue to remind the user about the availability of the product each time the hand-held object is picked up, held or used.

This innovative approach not only can help regulate the usage frequency of the product to desirable levels, but can also help increase demand and sales of the product because of the increased visual and physical presence of the product, to users as well as to bystanders.

The choking hazard risk of the dispenser is reduced or eliminated altogether given that introducing the dispenser attached to the larger hand-held object into the mouth is more difficult than introducing the smaller dispenser by itself into the mouth.

Further, the configuration of the dispenser secured to a hand-held object allows to further reduce the size of the dispenser from that of existing similar dispensers without accentuating any of the problems suffered by current dispensers, even reducing or eliminating the problems described above.

By providing a dispenser with a reusable, refillable dock 22, and a disposable receptacle 60, the need to detach the adhesive unit from the hand-held object in order to attach a new dispenser is eliminated. In addition, costs can be kept low by offering consumers the option to acquire only the receptacle portion if they have already purchased the unit with the dock. This modality can help promote brand loyalty and repeat purchase among consumers by encouraging reuse of the dock, again, increasing demand and sales of the product.

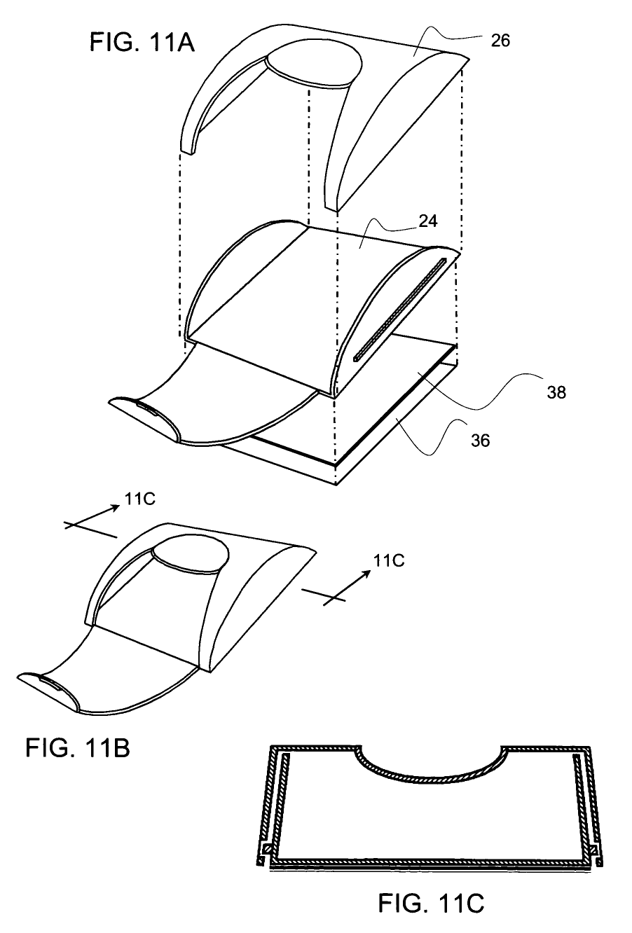

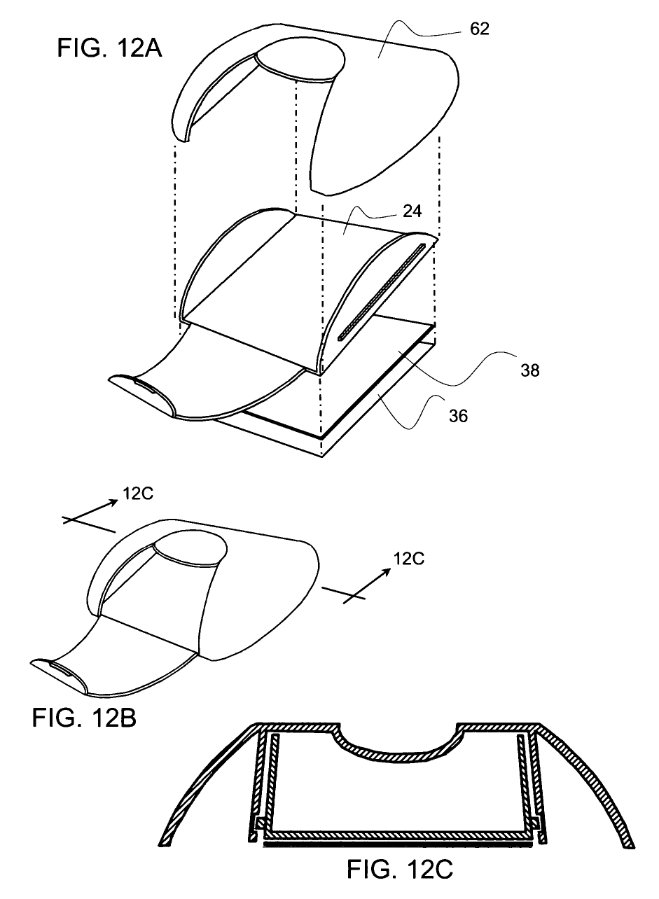

### FIGS. 11A-11C, 12A-12C—ADDITIONAL EMBODIMENTS

In other embodiments of my dispenser, there is no dock component but only a receptacle unit 60 with a cover 26 and where the undersurface of base 24 is directly laminated with double-sided adhesive tape 38, as seen as in FIGS. 11A (exploded view), 11B (perspective), and 11C (cross-section). Still other embodiments consist of an integrated cover 62 having a rounded outer surface and a base 24 directly laminated with double-sided adhesive tape 38 (no dock component), as seen as in FIGS. 12A (exploded view), 12B (perspective), and 12C (cross-section). Other embodiments (not shown) consist of the entire dispenser being made of a single piece where the outer surface may or may not be rounded, and the double-sided adhesive tape adhered to the undersurface of the piece.

Additional embodiments (not shown) include base 24 with walls running from the ends of walls 52 of base 24 to create a continuous enclosure around the entire perimeter of base 24 to keep the contents from spilling from base 24 while receiving the consumable contents on the production line.

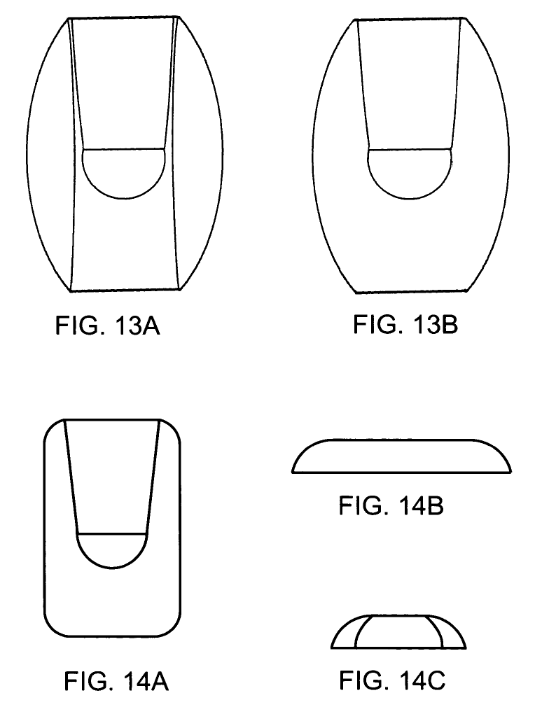

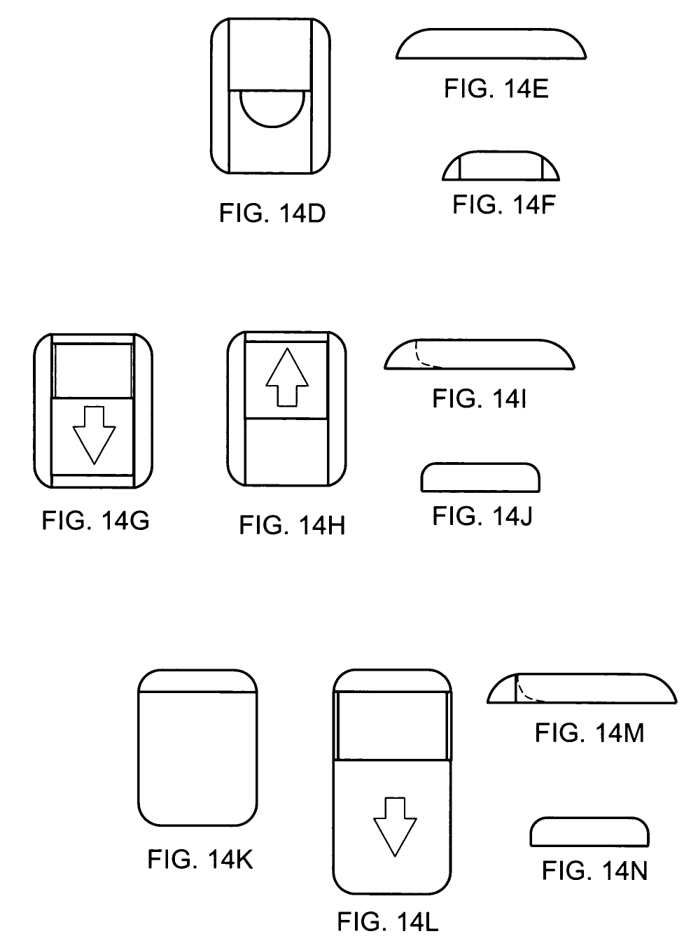

### FIGS. 13A-14N—ALTERNATIVE EMBODIMENTS

In addition, there are various possibilities with regard to alternative embodiments of my dispenser and its different configurations, iterations, and shapes as illustrated in FIGS. 13A and 13B, which present top views of these alternative embodiments. FIG. 13A shows a longer version with a dock, FIG. 13B shows a longer version without a dock. FIG. 14A shows a squarer version of the dispenser, FIG. 14B shows a side view, and FIG. 14C shows a front view of the dispenser in FIG. 14A. FIGS. 14D to 14F show a version with a square lid.

Still further alternative embodiments of my dispenser include a sliding lid adapted to slide back and forth along the top surface length of the body of the receptacle as seen in FIGS. 14GF to 14J. Still other embodiments include a cover structure fitted over a base structure where the cover is adapted to slide on top of the base, as shown in FIGS. 14K to 14N, where the cover structure acts as the lid.

Other alternative embodiments (not shown) include the dispenser, with or without dock portion; as an integral part of any hand-held or non-hand-held objects or devices, whether portable or noy, wearable objects such as wristwatches, or part of a front or back cover of any such object to which such dispenser may be a part thereof.

Such object may consist of popular and conventional everyday objects such as a cell phone, the battery pack of a cell phone, an MP3 player (example: IPOD® by Apple), a hand-held electronic game (example: GAMEBOY® by Nintendo), a personal music player (example: CD WALKMAN® by Sony), or a PDA (example: BLACKBERRY® by RIM). Other objects include a dictation device or voice recorder, a camera, a boom box, a radio, a hand-held calculator, a desktop calculator, a laptop computer, a wristwatch, a pen, a pencil, a book, an agenda, or any other such object, electronic or not; which may have been, is being, or which may be developed in the future.

### ADVANTAGES

From the description above, a number of advantages of my attachable dispenser become evident. When secured to a hand-held object:
(a) The likelihood of misplacing the dispenser is reduced or eliminated altogether in spite of the its reduced size, given that the larger hand-held object to which the dispenser is secured is more difficult to misplace than a small single dispenser,
(b) The dispenser is easy to detect when stored, whether visually or using the sense of touch (patted down) in spite of its low profile, given that the larger hand-held object to which the dispenser is secured is easier to detect when stored, whether visually (spotted) or using the sense of touch (patted down) than a similar traditional dispenser,
(c) The dispenser can be easily found when stored in a compartment containing other objects in spite of its reduced size, given that the larger hand-held object to which the dispenser is secured is easier to find when stored with other objects, than a similar traditional dispenser,
(d) The dispenser can be easily fetched and retrieved when stored in deep pockets and other hard-to-access compartments in spite of its reduced size, given that the larger hand-held object to which the dispenser is secured is easier to fetch and retrieve when stored in deep pockets and other hard-to-access compartments, than a similar traditional dispenser,
(e) The dispenser is easy and convenient to handle and operate (easy to hold, easy opening of the lid, easy removal and dispensing of contents, easy closing of the lid, etc), in spite of its small size and the reduced size of its parts, given that the larger hand-held object to which the dispenser is secured provides a superior holding body that improves handling and operation of the dispenser when compared to similar traditional dispensers,
(f) The dispenser remains stable and secure while being handled and operated, in spite of the small dimensions of the unit and its parts, given that the larger hand-held object to which the dispenser is secured provides improved handling and operating stability to the dispenser when compared to similar traditional dispensers,
(g) The dispenser is difficult to drop while being handled and operated, in spite of the small dimensions of the unit and its parts, given that the larger hand-held object to which the dispenser is secured provides a superior holding body which improves handling stability to the dispenser when compared to similar traditional dispensers,
(h) The likelihood of spilling the contents of the dispenser is reduced or eliminated altogether in spite of the reduced size of the dispenser, given that the larger hand-held object to which the dispenser is secured provides a superior holding body which improves handling stability to the dispenser, when compared to similar traditional dispensers,
(i) The dispenser can be stored in most types of compartments, including warm and/or humid pockets such as those that rest against the skin without causing the confections to stick to one another given that the hand-held object to which the dispenser is secured can be positioned into the compartment to act as a layer of insulation between the dispenser and the skin, thereby reducing the amount of heat and humidity that come in contact with the dispenser, when compared to similar traditional dispensers,
(j) When left exposed to direct sunlight, the configuration of the dispenser secured to the hand-held object can reduce the tendency of the confections to stick to one another in spite of the instant-dissolving feature of the confections given that the hand-held object to which the dispenser is secured can be placed in a position to block the sunlight, thereby reducing the amount of heat/humidity that builds up inside the dispenser, when compared to similar traditional dispensers,
(k) The configuration of the dispenser secured to the hand-held object can increase the likelihood that a user will use the product regularly by securing the dispenser on a surface of the hand-held object that comes in contact with the sense of touch and/or an eye-catching part of the object so as to provide a sensory and/or visual reminder to the user about the product each time the device is picked up, held or used,
(l) The configuration of the dispenser secured to the hand-held object can minimize or eliminate the choking hazard risk posed by the dispenser's small size given that the larger hand-held object to which the dispenser is secured is at least more difficult or nearly impossible to introduce into the mouth, when compared to similar traditional dispensers,
(m) Further reduction in the size of the dispenser from that of similar traditional dispensers is possible without accentuating any of the problems presented by current dispensers for breath fresheners as described under BACKGROUND OF THE INVENTION—PROBLEMS AND DISADVANTAGES OF PRIOR ART on pages 10 and 11; points (a) to (m), and
(n) At least part of the dispenser, such as in the case of the dock being refilled with a new receptacle unit, can be re-used to lower costs.

### CONCLUSION, RAMIFICATIONS, AND SCOPE

Accordingly, the reader will see that the attachable dispenser of this invention can be used by persons of almost any age to dispense confections easily and conveniently, reduces the likelihood of misplacing the dispenser, and makes the dispenser easier to find, fetch and retrieve. In addition, the dispenser allows for improved handling, operation, and increased stability, thereby reducing the risk of dropping and/or spilling its contents. It also allows storing in warm and humid compartments and/or left in sunlight without causing the confections to stick to one another.

By providing a sensory and/or visual reminder to the user about the product each time the object is picked up, held or used, the likelihood that a user will use the product regularly increases. In addition, the configuration of the dispenser attached to a hand-held object can reduce the choking hazard risk, and allows for the offering of an even smaller unit while improving the functionality of the dispenser. Furthermore, the portable dispenser for use with hand-held objects has the additional advantages in that:
it is simple and convenient to use as it allows opening, dispensing and closing using only one finger, while the rest of the hand holds the hand-held object as usual,
it allows the inexpensive offering of an improved dispenser by providing a sturdy refillable dock, whereby a consumer can purchase the complete unit including the dock the first time and only the disposable receptacle thereafter as needed,
it optimizes the efficacy of the breath freshening effect of the confection as it encourages regular and frequent use of the product,
it promotes repeat purchase as a result of the need to refill the dock,
it creates brand loyalty among consumers because of repeat purchases.

Although the description above contains many specificities, these should not be construed as limiting the scope of the invention but as merely providing illustrations of some of the presently preferred embodiments of this invention. For example, the dispenser can have other shapes, such as square, triangular, etc, the double-sided adhesive can be replaced by any other attachment mechanisms such as magnets, belts, hook-and-eye mechanisms (such as VELCRO® by Dupont), snap-on brackets, etc. The lid can be made to slide open instead of a lid that flips open using a living hinge, etc.

The dispenser can be adapted to dispense products other than breath strips, such as breath spheres or any other intense breath freshener which may be under development or which may be developed in the future; gum, pills, medicines, medications, legal drugs, and in general any product which may be appropriate for dispensing from hand-held and a non-hand-held objects, whether portable or not.

In addition, the dispenser, with or without refillable receptacle; can be made an integral part of any hand-held, non-hand-held, or any wearable object or device, or part of the front or back cover of any such object to which such dispenser can be attached or related to. Such objects consist of a cell phone, the battery pack of a cell phone, an MP3 player (example: IPOD® by Apple), a hand-held electronic game (example: GAMEBOY® by Nintendo), or a PDA (example: BLACKBERRY® by RIM). Other objects include a camera, a radio, a laptop computer, an agenda, or any other such object that may be developed in the future.

Thus the scope of the invention should be determined by the appended claims and their legal equivalents, rather than by the examples given.

I claim:

1. In a dispenser for portable consumables of the type comprising a receptacle having opening and closing means for releasing and retaining the consumables contained therein, the improvement wherein said dispenser has attachment means adapted thereon for securing said dispenser to hand-held objects

2. the dispenser of claim 1 wherein said receptacle is composed of polypropylene

3. the dispenser of claim 1 wherein the opening and closing means of said receptacle comprise:
(a) a cover structure, and
(b) a base structure,
(c) said cover structure slidably mounted on said base structure

4. the dispenser of claim 1, wherein:
(a) said receptacle has an aperture large enough on a surface thereof to allow the release of the consumables contained therein,
(b) said opening and closing means comprise a lid slidably mounted on said receptacle,
(c) said lid is adapted to slide over said aperture to close the receptacle and away from said aperture to allow access to the consumables contained therein,
(d) said receptacle comprising an outer body surface having a smooth and rounded contour,
(e) said smooth and rounded contour is arranged to provide anti-snag means for preventing said receptacle from snagging on cloth and other objects when said dispenser is attached to said hand-held objects,

5. the dispenser of claim 1, wherein:
(a) said receptacle has an aperture large enough on a surface thereof to allow access to the consumables contained therein,
(b) said opening and closing means comprise a lid attached to a hinge on an edge of said receptacle,
(c) said lid is disposed to pivot outwardly from said receptacle and inwardly to fit and snap snugly over said aperture,
(d) said receptacle has an outer body surface having a smooth and rounded contour,
(e) said smooth and rounded contour is arranged to provide anti-snag means for preventing said receptacle from snagging on cloth and other objects when said dispenser is attached to said hand-held objects,

6. the dispenser of claim 1 wherein said attachment means comprise:
(a) a layer of double-sided adhesive tape,
(b) a protective paper liner laminated to the undersurface of the tape, and
(c) said layer of double-sided adhesive tape being laminated to the undersurface of said receptacle

7. the dispenser of claim 1 wherein said attachment means comprise:
(a) a dock adapted to receive and secure said receptacle firmly, and onto which said receptacle can be removably secured,
(b) a layer of double-sided adhesive tape,
(c) a protective paper liner laminated to the undersurface of the tape, and
(d) said layer of double-sided adhesive tape being laminated on the undersurface of said dock

8. the dispenser of claim 7 wherein the combination of said dock and said receptacle conform the body of the dispenser

9. the dispenser of claim 8 wherein:
(a) said body has an outer surface having a smooth and rounded contour
(b) said smooth and rounded contour is arranged to provide anti-snag means for preventing said receptacle from snagging on cloth and other objects when said dispenser is attached to said hand-held objects,

10. the dispenser of claim 1 wherein said receptacle comprises:
(a) a cover structure,
(b) a base structure,
(c) said cover structure adapted to fit and snap over the base,
(d) said cover structure having an outer body surface and a smooth and rounded contour,
(e) said outer body surface and smooth and rounded contour providing anti-snag means for preventing the cover from snagging on cloth and other objects when said dispenser is attached to portable objects,

11. A dispenser arrangement for portable consumables, comprising:
(a) a receptacle,
(b) a lid structure providing opening and closing means integrated onto said receptacle for allowing access to and retention of the portable consumables contained in said receptacle,
(c) attachment means adapted to said receptacle for securing said dispenser to a predetermined hand-held object, and
(d) anti-snag means for preventing said dispenser from snagging on cloth and other objects when said dispenser is attached to said hand-held object,
whereby said hand-held object reduces the chances of misplacing said portable dispenser, provides an indicium of the dispenser to reinforce the presence of the dispenser and promote usage of the consumables contained therein, reduces the choking hazard risk posed by the smaller dispenser on its own, and provides an enlarged means for holding, handling, and operating the dispenser more conveniently, while keeping consistency with the portability and profile of the hand-held object to which the dispenser is attached.

12. A method of dispensing portable consumables from predetermined hand-held objects, comprising the steps of:
(a) providing a receptacle filled with portable consumables
(b) providing said receptacle with a lid for allowing the access to and retention of the portable consumables contained therein,
(c) laminating the undersurface of said receptacle with a double-sided adhesive tape,
(d) protecting the exposed side of said double-sided adhesive tape with a removable liner,
(e) providing a predetermined hand-held object,
(f) selecting a flat surface on the hand-held object to accommodate said receptacle,
(g) peeling off the liner from the tape and affixing the receptacle against said hand-held object,
(h) using the hand-held object as usual,
(i) opening the lid to dispense the product,
(j) removing the desired amount of product, and
(k) reclosing said lid of said dispenser
whereby said hand-held object provides a means to dispense portable consumables more conveniently, and reduces the likelihood of misplacing said dispenser.

13. the method of claim 12 wherein steps (a) and (b) are the same, and wherein steps (c) forward are substituted by the following steps:
(c) providing a dock adapted to receive said receptacle and onto which said receptacle can be removably secured,
(d) laminating the undersurface of said dock with a double-sided adhesive tape,
(e) protecting the exposed side of said double-sided adhesive tape with a removable liner,
(f) providing the predetermined hand-held object,
(g) selecting a flat surface on said hand-held object to accommodate said dock,
(h) peeling off the liner from the tape and affixing the dock against said hand-held object,
(i) securing the receptacle onto the dock,
(j) using the hand-held object as usual,
(k) opening the lid to dispense the product,
(l) removing the desired amount of product,
(m) reclosing said lid of said dispenser,
(n) urging the receptacle out of the dock once consumables are depleted,
(o) repeating steps (a) to (n)
whereby said dispenser provides a means to dispense portable consumables more conveniently from a hand-held object, allows for expedient refilling, reduces the likelihood of misplacing said dispenser, provides an indicium of the dispenser to remind a user to consume the portable consumables contained therein and promotes the comsumption of said consumables.
